(19) United States
(12) Patent Application Publication
(10) Pub. No.: US 2007/0026786 A1
(43) Pub. Date: Feb. 1, 2007

(54) Variable source diameter stack system and method

(76) Inventor: Mingsheng Liu, Omaha, NE (US)

Correspondence Address: MICHAEL BEST & FRIEDRICH, LLP, 100 E WISCONSIN AVENUE, MILWAUKEE, WI, 53202, US

(21) Appl. No.: 11/490,537

(22) Filed: Jul. 20, 2006

Related U.S. Application Data
(60) Provisional application No. 60/701,594, filed on Jul. 22, 2005.

(51) Int. Cl. B08B 15/02

(52) U.S. Cl. 454/61

(57) ABSTRACT

A fume exhaust stack system that includes an exhaust stack, at least one fume hood, a plurality of stack pieces, a retractable expander, a sensor, and a controller. The exhaust stack is coupled to the at least one fume hood and is adapted to emit exhaust conveyed by the at least one fume hood. The retractable expander is positioned at the exhaust stack, and is moveable between a first position in which the retractable expander is extended and a second position in which the retractable expander is retracted relative to the first position. Movement of the retractable expander between the first and second positions is operable to adjust a cross-sectional area of the exhaust stack. Based on an output signal from the sensor, the controller outputs a control signal to move the retractable expander into one of the first and second positions.

### RELATED APPLICATION

This application claims priority to U.S. Provisional Patent Application Ser. No. 60/701,594, filed on Jul. 22, 2005, the entire contents of which are incorporated herein by reference.

### FIELD

Embodiments of the invention relate generally to exhaust systems and methods, and particularly to systems and methods to improve efficiency of central exhaust systems.

### BACKGROUND

Various types of facilities, such as research buildings, industry production facilities, medical buildings, manufacturing assemblies, and laboratories, often use exhaust systems equipped with fume hoods in order to process toxic fumes. Generally, an exhaust system includes a fan by which to draw fumes into the exhaust system, and a stack system by which to emit fumes into the atmosphere at predetermined altitudes.

Differential safety requirements generally dictate the altitudes at which fumes are to be exhausted. To reach those altitudes, exhaust systems must emit fumes at predetermined velocities and pressures. For example, a make-up damper linked to the exhaust system can be opened to maintain a constant static pressure either at the fume hoods or at an inlet of the fan, when the fan is run at a constant speed. In such cases, however, the fan continues to consume the designed power regardless of the level of exhaust. In some cases, the fan can consume 50 percent more power than actually required. In addition, when airflow is low, excessive negative static pressure can result, which leads to noise problems and control stability problems with respect to operation of the fume hoods.

### SUMMARY

Embodiments of the invention provide an energy-efficient exhaust system that can be installed as a new exhaust system or can be retrofitted to existing exhaust systems.

In one embodiment, the invention provides a fume exhaust stack system that includes an exhaust stack, at least one fume hood, a plurality of stack pieces, a retractable expander, a sensor, and a controller. The exhaust stack is coupled to the at least one fume hood, and is adapted to emit exhaust conveyed by the at least one fume hood. The retractable expander is positioned at the exhaust stack and is moveable between a first position in which the retractable expander is extended and a second position in which the retractable expander is retracted relative to the first position. Movement of the retractable expander between the first and second positions is operable to adjust a cross-sectional area of the exhaust stack. The sensor is positioned near the exhaust stack and outputs a signal indicative of an exhaust condition. The controller is coupled to the sensor, receives the output signal from the sensor, and, based on the output signal, outputs a control signal to move the retractable expander into one of the first and second positions.

In another embodiment, the invention provides a method of controlling exhaust emissions from an exhaust stack having a plurality of stack pieces, wherein a retractable expander is positioned at the plurality of stack pieces. The method includes sensing an exhaust condition at the exhaust stack, comparing the condition with a threshold, retracting the retractable expander to reduce a cross-sectional area of the exhaust stack when the condition is below the threshold, and extending the retractable expander to enlarge the cross-sectional area of the exhaust stack when the condition is above the threshold.

Other aspects of the invention will become apparent by consideration of the detailed description and accompanying drawings.

### BRIEF DESCRIPTION OF THE DRAWINGS

FIG. 1 is a schematic of a fume exhaust stack system.

FIG. 2 is a perspective view of a variable diameter stack that can be used with the fume exhaust stack system of FIG. 1.

FIG. 3 is a top view of the variable diameter stack of FIG. 2.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Embodiments of the invention provide fume exhaust stack systems that include a variable diameter stack. Embodiments herein can control an exit velocity of exhaust by adjusting a diameter of the stack when the exhaust airflow rate changes. Additionally, embodiments herein can maintain a constant static pressure or a required static pressure at different locations of a fume exhaust stack system. In some embodiments, a retractable expander is employed to adjust the diameter. In other embodiments, a fume exhaust stack system includes a fan that is controlled by a controller and a variable frequency drive. By modulating the speed of the fan, the fume exhaust stack system can minimize power consumption.

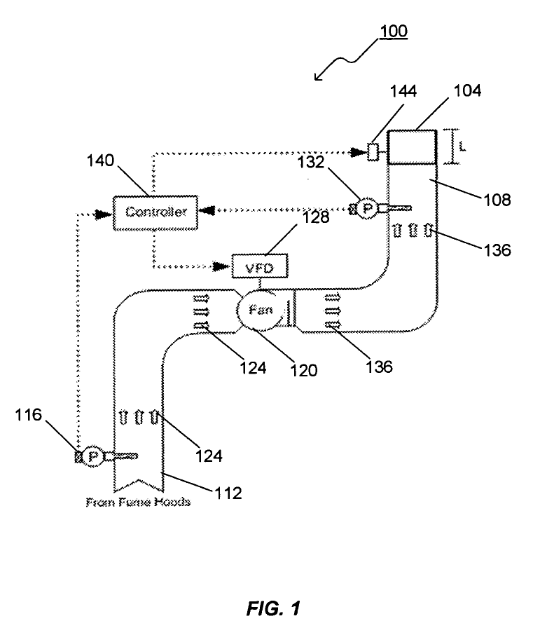

FIG. 1 is a schematic of a fume exhaust stack system 100 having a variable diameter stack (“VDS”) 104 on top of an outlet duct 108. The fume exhaust stack system 100 includes one or more fume hoods (not shown) coupled to an inlet duct 112. The fume exhaust stack system 100 also includes a first sensor 116 located at the inlet duct 112. The fume exhaust stack system 100 uses a fan 120 to draw exhaust from the fume hood(s) to the inlet duct 112 in a direction indicated by arrows 124. In the embodiment shown, a variable frequency drive (“VFD”) 128 drives the fan 120 and controls a speed of the fan 120. The fume exhaust stack system 100 also includes a second sensor 132 located below the VDS 104 in the outlet duct 108. The fan 120 continues to convey the exhaust to the outlet duct 104 in a direction indicated by arrows 136.

The sensors 116, 132 monitor, sense, measure, or determine one or more conditions of the fume exhaust stack system 100. For example, the sensors 116, 132 sense conditions indicative of a static pressure at the respective inlet duct 112 and outlet duct 108. Sensed conditions can then be converted into calibrated signals that are indicative of the static pressures of the fume exhaust stack system 100. The sensors 116, 132 can be equipped with calibration circuitry and/or microprocessors that internally convert the static pressures to a calibrated form. Alternatively, the sensed conditions can be converted into calibrated signals by other external processes or devices in a manner known in the art. In the embodiment shown, the sensor 116 measures a static pressure near the inlet duct 112, and the sensor 132 measures a total static pressure near the outlet duct 108. Although only one sensor is shown at the inlet duct 112 and the outlet duct 108, respectively, the fume exhaust stack system 100 can include additional sensors.

In some embodiments, the fume exhaust stack system 100 includes multiple fume hoods. In such embodiments, the fume hoods can be connected to the inlet duct 112 via ductwork, and the first pressure sensor 116 can be mounted near the fume hood that is farthest from the fan 120.

A controller 140 receives the sensed conditions from the sensors 116, 132, processes the conditions, and adjusts the VFD 128 and an actuator 144. For example, the controller 140 compares each of the sensed conditions with a corresponding condition set point stored in a memory (not shown) of the fume exhaust stack system 100, or in the controller 140. Once the controller 140 has compared each of the sensed conditions with the corresponding condition set point, the controller 140 adjusts the speed of the fan 120. For example, in the embodiment shown, when the static pressure determined at the first sensor 116 near the inlet duct 112 is greater than the corresponding static pressure set point at the inlet duct 112, the controller 140 speeds up the fan 120 via the VFD 128. Conversely, when the static pressure determined at the first sensor 116 near the inlet duct 112 is less than the corresponding static pressure set point at the inlet duct 112, the controller 140 slows down the fan 120 via the VFD 128.

Furthermore, when the second condition determined at the second sensor 132 is greater than the corresponding set point, the controller 140 sends a signal to the actuator 144 to enlarge a cross-sectional area or a diameter of the VDS 104. Conversely, when the second condition determined at the second sensor 132 is less than the corresponding set point, the controller 140 sends a signal to the actuator 144 to reduce a cross-sectional area or a diameter of VDS 104.

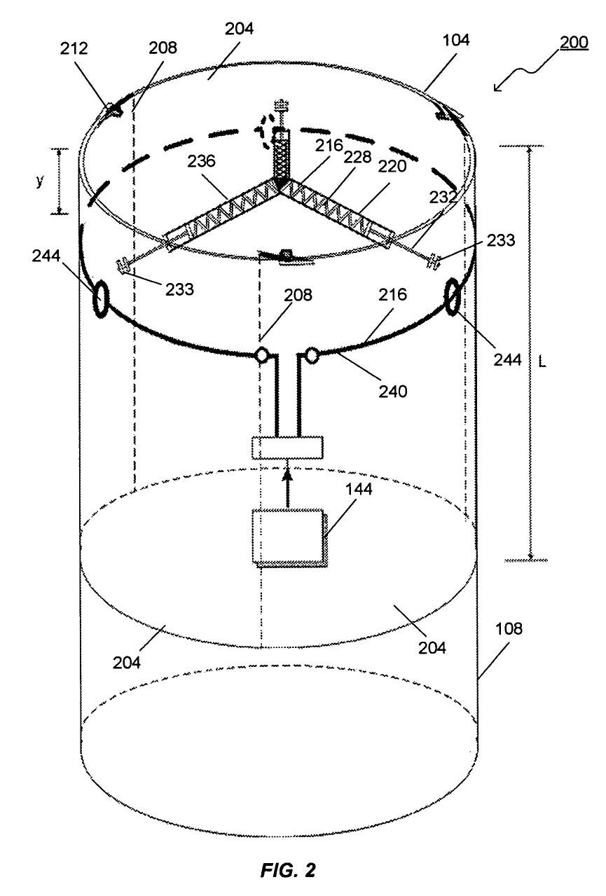

FIG. 2 is a perspective view of an exemplary variable diameter stack system 200 that can be used to implement the VDS 104 of FIG. 1, wherein like numerals are used to refer to like parts. The VDS 104 includes two or more stack pieces 204 resulting from vertically cutting a portion of the outlet duct 108. In some embodiments, the stack pieces 204 are of equal height. Each of the stack pieces 204 is joined to another of the stack pieces 204 at a joint 208 with a seal 212. Although three stack pieces 204 are shown in FIG. 2, the VDS 104 can include more stack pieces 204. When joined together with the seals 212, the stack pieces 204 form a substantially cylindrical VDS 104 with a cross-sectional area and a stack diameter that are substantially similar to those of the outlet duct 108. In some embodiments, the length (L) of each of the stack pieces 204 or the vertical cut is expressed in EQN. (1).

$$L = \frac{1 - \sqrt{α}}{2 sin β} \qquad ( 1 )$$

In EQN. (1), α is a ratio between a minimum desired exhaust airflow rate and a maximum desired exhaust airflow rate, and β is a maximum allowable bend angle of a stack piece 204 that depends on materials used for the stack pieces 204. In some embodiments, the maximum allowable bend angle of the stack piece 204 is less than about 15°. In some embodiments, the length L is generally less than two times the variable stack diameter.

In the embodiment shown, the seals 212 are made of corrosion-resistant rubber. However, the seals 212 can be made of other corrosion-resistant materials. The mechanical properties of the seals 212, aided by the static pressure at the outlet duct 108, substantially prevent air leakage at the joints 208.

FIG. 2 also shows a retractable expander assembly 216 that can be actuated by the actuator 144. In the embodiment shown, the retractable expander assembly 216 includes multiple spring arms 220 positioned within the VDS 104. In some embodiments, the spring arms 220 are spaced apart radially in an equiangular manner. Each of the spring arms 220 includes a spring 228 and an expander rod or extendable arm 232 contained in a guide track or housing 236. One end of the extendable arm 232 is supported by the spring 228 in the housing 236, and the other end of the extendable arm 232 protrudes from the housing 236 and is mounted on a stack piece 204 at a midpoint 233 between the joints 208 of the stack pieces 204. In the embodiment shown, the housing 236 is about 60 percent of the length of the spring arm 220, and the extendable arm 232 is about 40 percent of the length of the spring arm 220. In other embodiments, other dimensional ratios can be used. The distance between the top edge of the VDS 104 and the midpoint 233 can be determined based on EQN. (2).

$$Y = ( \frac{1 - \sqrt{α}}{2} - Z ) / sin β \qquad ( 2 )$$

In EQN. (2), Y is a distance from the top of the VDS 104 to the midpoint 233, and Z is a ratio between a length of the extendable arm 232 and the stack diameter. When extended, the spring arms 220 push the stack pieces 204 radially outwardly, thereby enlarging the diameter of the VDS 104. When retracted, the spring arms 220 move radially inwardly, thereby reducing the diameter of the VDS 104.

In the embodiment shown, the retractable expander 216 also includes a chain 240 guided by a plurality of guide rings 244 positioned external to the VDS 104. In other implementations, other types of devices can be employed in lieu of a chain, such as cable, wire, rope, other devices including links, or compressive devices (e.g., a vise positioned external to the stack pieces 204). As shown, each of the stack pieces 204 has one guide ring 244. The guide rings 244 are generally mounted on an exterior center of the stack piece 204. In the embodiments shown, the maximum distance between a guide ring 244 and the midpoint of the joints 208 is less than 10 percent of the stack diameter. In other embodiments, a stack piece 204 may have multiple guide rings 244. During operation of the fume exhaust stack system 200, the chain 240 is generally wrapped around the VDS 104. When the actuator 144 extends the chain 240, the stack pieces are released tangentially, thereby enlarging the cross-sectional area. Conversely, when the actuator 144 retracts the chain 240, the stack pieces 204 are compressed tangentially, thereby reducing the cross-sectional area. In some embodiments, the actuator 144 uses linear or rotational motion to extend or to retract the chain 240.

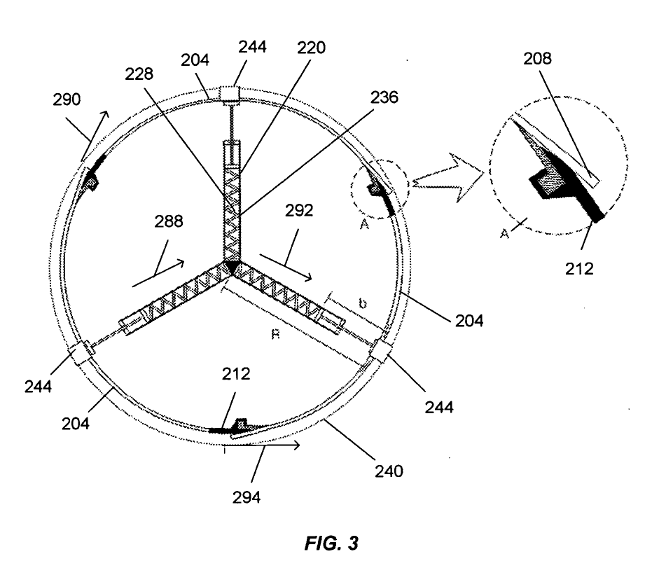

FIG. 3 is a top view of the VDS 104 of FIG. 2. View A of FIG. 3 shows that each of the stack pieces 204 is joined to another of the stack pieces 204 at the joint 208 with a seal 212. In addition, the spring arms 220 have a length of R, and the extendable arms 232 have a length of b. The stack diameter is therefore 2R.

As described earlier, when the chain 240 is retracted, the extendable arms 232 are compressed against the springs 228. The extendable arms 232 are therefore pushed by the stack pieces 104 inwardly. As a result, the VDS 104 is compressed radially inwardly in a direction indicated by arrow 288, while the stack pieces 204 are compressed tangentially in a direction indicated by arrow 290. Thus, R and b are reduced, thereby reducing the diameter and the cross-sectional area of the VDS 104.

When the chain 240 is extended, pressure is exerted on the extendable arms 232, resulting in lessened pressure against the springs 228. As such, the extendable arms 232 push against the stack pieces 204 until the extendable arms 232 protrude from the housing 236 by a value of b, and the stack pieces 204 are released tangentially in a direction indicated by arrow 294. As a result, the VDS 104 can expand radially outwardly in a direction indicated by arrow 292. Thus, R and b are increased, thereby enlarging the diameter and the cross-sectional area of the VDS 104.

Accordingly, when the condition determined at the second sensor 132 of FIG. 1 is greater than a predetermined condition set point, the chain 240 can be extended, thus enlarging the cross-sectional area of the VDS 104 in order to cause the condition to decrease and converge with the set point. Conversely, when the condition determined at the second sensor 132 of FIG. 1 is less than the predetermined condition set point, the link 240 can be retracted, thus reducing the cross-sectional area of the VDS 104 in order to cause the condition to increase and converge with the set point.

Other embodiments of the invention may be implemented. For instance, in addition to, or in lieu of, a chain placed external to the stack pieces 204, an actuator may be positioned in or near the housing 236 to electromechanically expand and retract the extendable arms 232. It is to be appreciated that such components may need to have corrosion-resistant properties.

Various features of the invention are set forth in the following claims.

What is claimed is:

1. A fume exhaust stack system comprising:
an exhaust stack coupled to at least one fume hood and adapted to emit exhaust conveyed by the at least one fume hood, the exhaust stack having a plurality of stack pieces;
a retractable expander positioned at the exhaust stack, the retractable expander moveable between a first position in which the retractable expander is extended and a second position in which the retractable expander is retracted relative to the first position, wherein movement of the retractable expander between the first and second positions is operable to adjust a cross-sectional area of the exhaust stack;
a sensor positioned near the exhaust stack and operable to output a signal indicative of an exhaust condition; and
a controller coupled to the sensor, the controller configured to receive the output signal from the sensor and, based on the output signal, output a control signal to move the retractable expander into one of the first and second positions.

2. The stack system of claim 1, wherein the exhaust condition comprises at least one of a pressure and an airflow rate.

3. The stack system of claim 1, wherein one of the plurality of stack pieces is joined to another of the plurality of stack pieces with a seal.

4. The stack system of claim 3, wherein the seal comprises a corrosion-resistant material.

5. The stack system of claim 1, wherein the retractable expander comprises a plurality of spring arms positioned within the exhaust stack and operable to be extended to push the plurality of stack pieces radially outwardly to enlarge the cross-sectional area, and to be retracted to pull the plurality of stack pieces radially inwardly to reduce the cross-sectional area.

6. The stack system of claim 1, wherein the retractable expander comprises a chain positioned external to the exhaust stack and operable to be extended to release the plurality of stack pieces tangentially to enlarge the cross-sectional area, and to be retracted to compress the plurality of stack pieces tangentially to reduce the cross-sectional area.

7. The stack system of claim 6, the stack system further comprising an actuator operable to extend the chain and to retract the chain based on the control signal.

8. The stack system of claim 1, wherein the controller is further configured to compare the exhaust condition with a predetermined threshold.

9. The stack system of claim 1, further comprising a fan configured to draw the exhaust from the at least one fume hood, and to emit the exhaust from the exhaust stack.

10. The stack system of claim 9, further comprising a variable frequency drive adapted to drive the fan at different speeds.

11. A method of controlling exhaust emissions from an exhaust stack having a plurality of stack pieces, a retractable expander being positioned at the plurality of stack pieces, the method comprising:
sensing an exhaust condition at the exhaust stack;
comparing the condition with a threshold;
retracting the retractable expander to reduce a cross-sectional area of the exhaust stack when the condition is below the threshold; and
extending the retractable expander to enlarge the cross-sectional area of the exhaust stack when the condition is above the threshold.

12. The method of claim 11, wherein the exhaust condition is at least one of a pressure and an airflow rate.

13. The method of claim 11, wherein the retractable expander comprises a plurality of spring arms positioned within the exhaust stack, and wherein extending the retractable expander comprises extending the spring arms to push the plurality of stack pieces radially outwardly.

14. The method of claim 11, wherein the retractable expander comprises a chain positioned external to the exhaust stack, and wherein extending the retractable expander comprises extending the chain to release the plurality of stack pieces tangentially.

15. The method of claim 14, further comprising:
generating a control signal when the condition is below or above the threshold; and
activating an actuator to extend the chain based on the control signal.

16. The method of claim 11, wherein the retractable expander comprises a chain positioned external to the exhaust stack, and wherein retracting the retractable expander comprises retracting the chain to compress the plurality of stack pieces tangentially.

17. The method of claim 16, further comprising:
generating a control signal when the condition is below or above the threshold; and
activating an actuator to retract the chain based on the control signal.

18. The method of claim 11, further comprising:
determining a speed at which exhaust is to be exhausted from the plurality of stack pieces; and
emitting exhaust from the exhaust stack at the speed.

19. The method of claim 18, wherein emitting exhaust from the exhaust stack at the speed comprises adjustably controlling a speed of a fan.
